(19) United States
(12) Patent Application Publication
(10) Pub. No.: US 2007/0038708 A1
(43) Pub. Date: Feb. 15, 2007

(54) Electronic mail distribution via a network of computer controlled display terminals with interactive display interfaces offering a sender creating an E-mail message proposed recipients based upon E-mail wording

(76) Inventors: Balaji V. Atyam, Austin, TX (US); Franck Barillaud, Austin, TX (US); Matthew Cali, Wake Forest, NC (US); Anita Govindjee, Ithaca, NY (US); Alfredo Mendoza, Georgetown, TX (US)

Correspondence Address: IBM CORPORATION;INTELLECTUAL PROPERTY LAW, 11400 BURNET ROAD, AUSTIN, TX, 78758, US

(21) Appl. No.: 11/201,646

(22) Filed: Aug. 11, 2005

(51) Int. Cl. G06F 15/16

(52) U.S. Cl. 709/206

(57) ABSTRACT

Sending E-Mail including the conventional implementation enabling the sender of an electronic mail document to specify users to receive the document; but, in addition, the process invites the sender creating the E-Mail to prompt the sender with more potential recipients as the sender, proceeds with the creation of the E-Mail message. An address book is maintained including the E-Mail addresses of a set of names of selected recipients who regularly receive E-Mail from the sender. Then, there is monitoring the text being entered for words with initial capital letters combined with an implementation responsive to the monitoring for determining if a located word with an initial capital corresponds to a name in said address book. The corresponding name to the designated recipients of the E-Mail message provided the sender interactively agrees to do so. Optionally, the system may be set up so the monitoring is for two consecutive words with initial capitals corresponding to the first and last name of a recipient in said address book.

### TECHNICAL FIELD

The present invention relates to computer managed communication networks, such as the World Wide Web (Web), and particularly to electronic mail (E-Mail) messages transmitted over such networks to display terminals.

### BACKGROUND OF RELATED ART

The past decade has been marked by a technological revolution driven by the convergence of the data processing industry with the consumer electronics industry. The effect has, in turn, driven technologies that have been known and available but relatively quiescent over the years. A major one of these technologies is the Internet or Web related distribution of documents. The Web or Internet, which had quietly existed for over a generation as a loose academic and government data distribution facility, reached “critical mass” and commenced a period of phenomenal expansion. With this expansion, businesses and consumers have direct access to all matter of documents and media through the Web. Also, as a result of the rapid expansion of the Web, E-Mail, which has been distributed for over 25 years over smaller private and specific purpose networks, has moved into distribution over the Web because of the vast distribution channels that are available.

The availability of extensive E-Mail distribution channels has made it possible to keep all necessary parties in business, government and public organizations completely informed of all transactions that they need to know about at almost nominal costs. However, there can be too much of a good thing. The availability of cheap E-Mail has led to an undesirable proliferation of E-Mail that many executive, management, professional and technical individuals are forced to handle. There has been a tendency on the part of senders of E-mail to make up the list of recipients of the E-mail prior to starting to write the E-mail message. This has led to mailing list of recipients wholly out of proportion to a reasonable number. The E-mail industry has been seeking implementations for controlling the number of necessary recipients of E-mail. The present invention provides one such effective implementation

### SUMMARY OF THE PRESENT INVENTION

The present invention provides an electronic mail distribution system for a network, e.g. Internet E-Mail transmitted between interactive display terminals. The invention offers a solution to the above problem of too many listed recipients of E-Mail by providing a display interface at a sending terminal including the conventional means enabling the sender of an electronic mail document to specify users to receive the document; but, in addition the invention provides means that invites the sender creating the E-Mail to initially limit the number of designated recipients because the process will prompt the sender with more potential recipients as the sender proceeds with the creation of the E-Mail message. An address book is maintained including the E-Mail addresses of a set of names of selected recipients who regularly receive E-Mail from the sender. Then, there are means for monitoring the text being entered for words with initial capital letters combined with means responsive to these monitoring means for determining if a located word with an initial capital corresponds to a name in said address book. There are means for adding the corresponding name to the designated recipients of the E-Mail message provided the sender interactively agrees to do so.

Optionally, the system may be set up so that the monitoring is for two consecutive words with initial capitals. The determining would be for located two consecutive words with initial capitals corresponding to the first and last name of a recipient in said address book. One aspect of this invention involves attaching a text document to said E-Mail message, scanning the attached text document for words with initial capital letters, determining if a located word with an initial capital corresponds to a name in said address book, and adding said corresponding name to said designated recipients of the E-Mail message as described above.

### BRIEF DESCRIPTION OF THE DRAWINGS

The present invention will be better understood and its numerous objects and advantages will become more apparent to those skilled in the art by reference to the following drawings, in conjunction with the accompanying specification, in which:

FIG. 1 is a block diagram of a data processing system including a central processing unit and network connections via a communications adapter that is capable of implementing the interactive display terminals, as well as servers in the Internet or Web E-Mail distribution of this invention;

FIG. 2 is a generalized view of an E-Mail distribution system in a Web or Internet that may be used in the practice of the present invention;

FIG. 3 is a diagrammatic illustration of an interactive display interface used for the writing of an E-Mail document after a word with an initial capital has been found, and a menu has been dropped down prompting the sender with a set of matching entries from address book so that sender may decide whether to add any of the entries to the recipient list for the E-Mail;

FIG. 4 is the display interface of FIG. 3 after the sender has selected to add Sam Shaw to list of recipients for the E-Mail;

FIG. 5 is a display interface like that of FIG. 4 but another word with an initial capital has been recognized;

FIG. 6 is the display interface of FIG. 5 after another recipient has been selected for the E-Mail based upon the interactive prompt of FIG. 5;

FIG. 7 is an illustrative flowchart describing the setting up of the functions to distribute E-Mail subject to the automatic offering of suggested recipients of the present invention; and

FIG. 8 is a flowchart of an illustrative run of the program set up according to FIG. 7.

### DETAILED DESCRIPTION OF THE PREFERRED EMBODIMENT

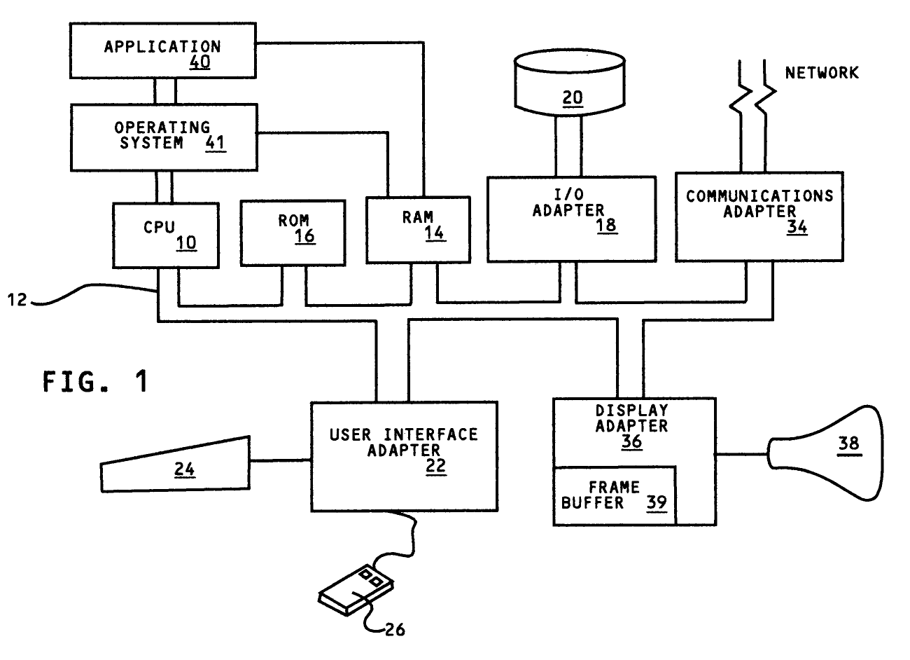

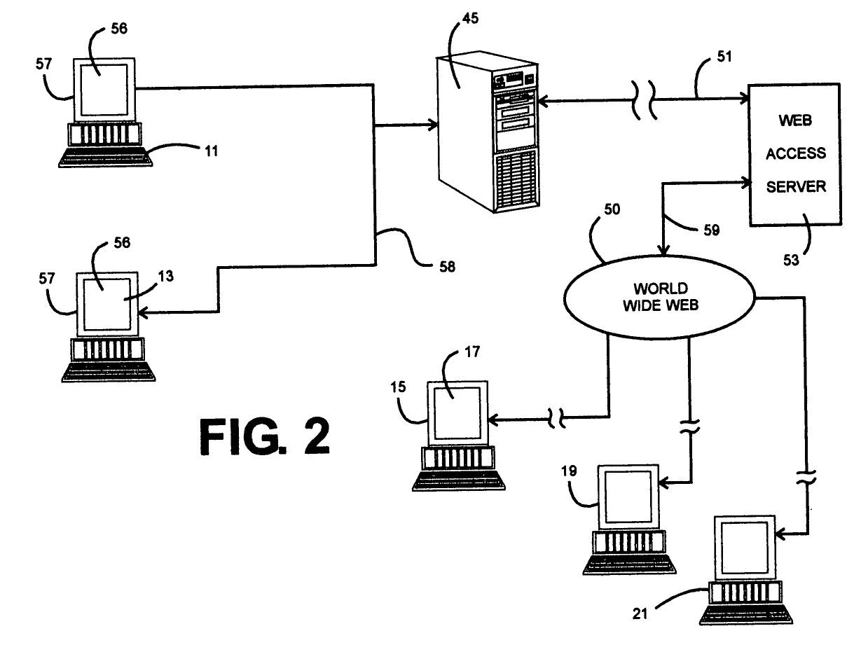

Referring to FIG. 1, a typical data processing system is shown that may function as the computer controlled network terminals or Web stations used conventionally as any of the sending or receiving Web stations for electronic mail transmission. The system shown is also illustrative of any of the server computers used for the Web E-Mail distribution to be described in greater detail with respect to FIG. 2.

A central processing unit (CPU) 10, may be one of the commercial microprocessors in personal computers available from International Business Machines Corporation (IBM) or Dell Corporation; when the system shown is used as a server computer at the Web distribution site to be subsequently described, then a workstation is preferably used, e.g. RISC System/6000™ (RS/6000) series available from IBM. The CPU is interconnected to various other components by system bus 12. An operating system 41 runs on CPU 10, provides control and is used to coordinate the function of the various components of FIG. 1. Operating system 41 may be one of the commercially available operating systems such as the AIX 6000™ operating system available from IBM; Microsoft's Windows XP™ or Windows2000™, as well as UNIX and IBM AIX operating systems. Application programs 40, controlled by the system, are moved into and out of the main memory Random Access Memory (RAM) 14. These programs include the programs of the present invention for prompting senders of E-Mail documents to add recipients of E-Mail in response to the entering of one or two words with initial capital letters. Where the computer system shown functions as the receiving Web station, then any conventional Web browser application program, such as the Microsoft's Internet Explorer™, will be available for accessing E-Mail from the Web and for sending E-Mail to the Web from the network station. A Read Only Memory (ROM) 16 is 15 connected to CPU 10 via bus 12 and includes the Basic Input/Output System (BIOS) that controls the basic computer functions. RAM 14, I/O adapter 18 and communications adapter 34 are also interconnected to system bus 12. I/O adapter 18 communicates with the disk storage device 20. Communications adapter 34 interconnects bus 12 with the outside network enabling the computer system to communicate with other such computers over the Web or Internet. The latter two terms are meant to be generally interchangeable and are so used in the present description of the distribution network. I/O devices are also connected to system bus 12 via user interface adapter 22 and display adapter 36. Keyboard 24 and mouse 26 are all interconnected to bus 12 through user interface adapter 22. It is through such input devices that the user at a receiving station may interactively relate to the Web in order to send E-Mail. Display adapter 36 includes a frame buffer 39 that is a storage device that holds a representation of each pixel on the display screen 38. Images may be stored in frame buffer 39 for display on monitor 38 through various components, such as a digital to analog converter (not shown) and the like. By using the aforementioned I/O devices, a user is capable of inputting information to the system through the keyboard 24 or mouse 26 and receiving output information from the system via display 38.

Before going further into the details of specific embodiments, it will be helpful to understand from a more general perspective the various elements and methods that may be related to the present invention. Since a major aspect of the present invention is directed to E-Mail documents transmitted over networks, an understanding of networks and their operating principles would be helpful. We will not go into great detail in describing the networks to which the present invention is applicable. Reference has also been made to the applicability of the present invention to a global network, such as the Internet or Web. For details on Internet nodes, objects and links, reference is made to the text, Mastering the Internet, G. H. Cady et al., published by Sybex Inc., Alameda, Calif., 1996. The Internet or Web is a global network of a heterogeneous mix of computer technologies and operating systems. Higher level objects are linked to the lower level objects in the hierarchy through a variety of network server computers. E-Mail is distributed through such a network.

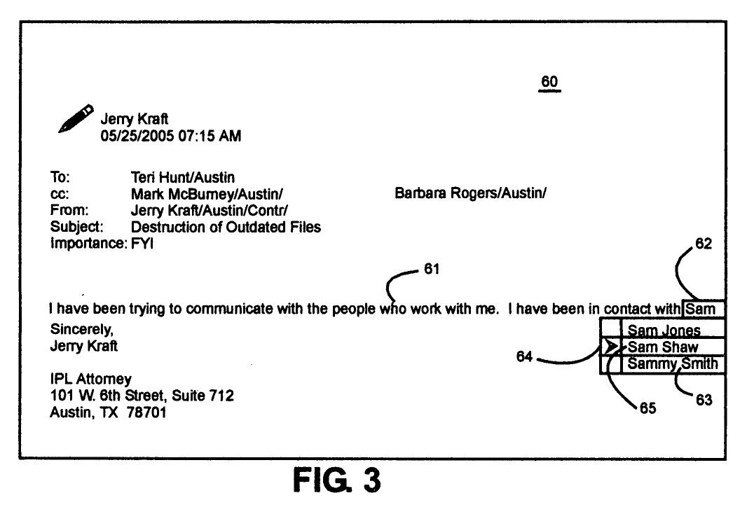

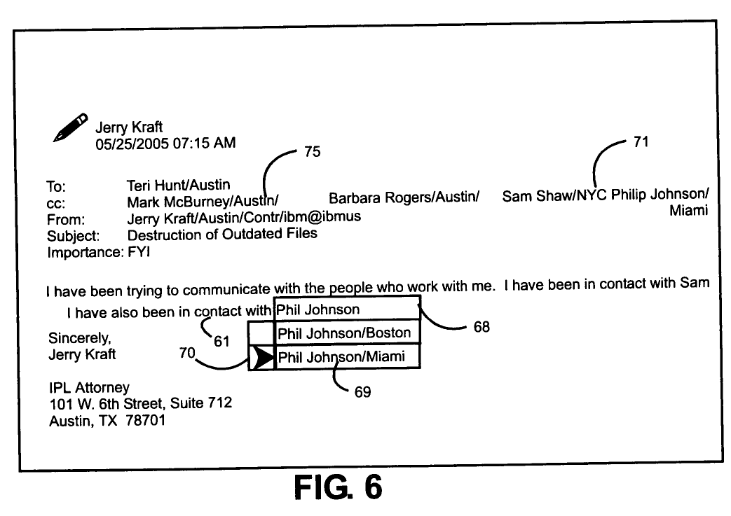

A generalized diagram of a portion of the Web for illustration of the E-Mail distribution system of the present invention is shown in FIG. 2. The computer controlled display terminals 11 and 13 have displays 57 upon which E-Mail documents 56 may be created by senders and displayed. Terminals 11 and 15 may be implemented by the computer system set up in FIG. 1, and connection 58 (FIG. 2) is the network connection shown in FIG. 1. For purposes of the present embodiment, terminals 11 and 13 serve as a Web display station for sending of E-Mail via the display interfaces to be described with respect to FIGS. 3 through 6 via Web browser programs. Reference may be made to the above-mentioned Mastering the Internet, pp. 136-147, for typical connections between local display stations to the Web via network servers, any of which may be used to implement the system on which this invention is used. In the typical set up shown, terminals are connected via, let us say, host dial connections (not shown) to server 45 provided by a Web Service Provider that in turn accesses the Web 50 via connection 51 to a Web access server 53 and connection 59. For the purpose of this embodiment, E-Mail is created on either terminal 11 or 13, and sent over the Web 50 to receiving terminals 15, 19 or 21.

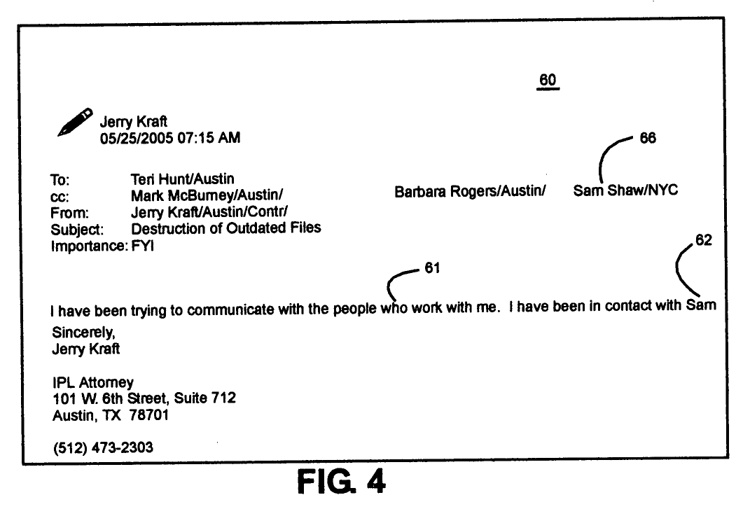

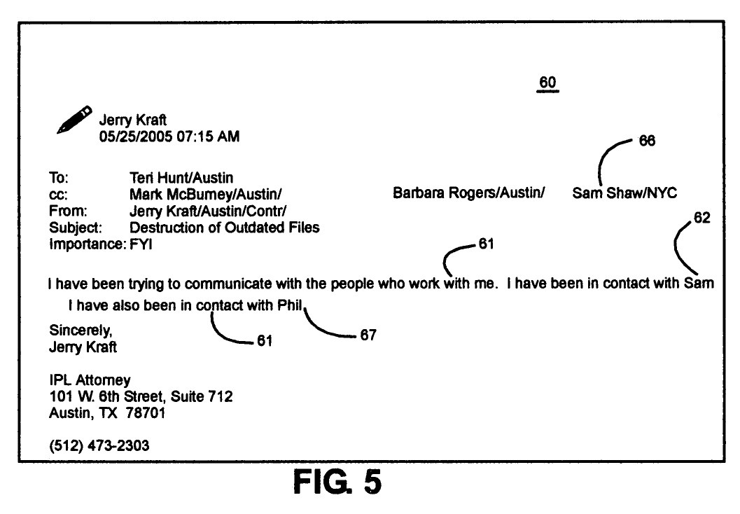

Within this E-Mail network set up, we will now consider the illustrative E-Mail distribution to be described with respect to FIGS. 3 through 6. In FIG. 3, there is illustrated an E-Mail document or letter 60 being created by a sender as shown in FIG. 2, e.g. E-Mail 56 on sending terminals 11 or 13. The sender first enters the recipients of the E-Mail message, both the addressee and those to receive copies. Then, as the sender enters text 61, when the text being monitored reaches a word with an initial capital, “Sam” 62; it is highlighted and a determination is made as to whether it is a name, e.g. nickname in the address book. Here it was found that there were three comparisons in the address book and a menu 63 was dropped listing the three names. The user selected 64 “Sam Shaw” 65 interactively by mouse pointer. If the user made no selection, then the text entry would have proceeded in the normal manner with “Sam” remaining as just a word. However, in the present case, as shown in FIG. 4, “Sam Shaw” appears 66 among the recipients of copies. Assuming a continuance of text entry 61, FIG. 5, “Phil” 67 is reached in FIG. 5. Either because the name “Phil” alone is not in the address book or the monitoring system is set up to require two consecutive words with initial capitals, no highlighting or menu of address book matches appears. Thus, text entry 61 continues until the two consecutive words with initial capitals, “Phil Johnson”, 68 are entered. It is highlighted, and a menu 69 drops down showing two comparisons in the address book, of which the sender selects “Philip Johnson, Miami” 70. This results in an addition 71 to the list of recipients 75.

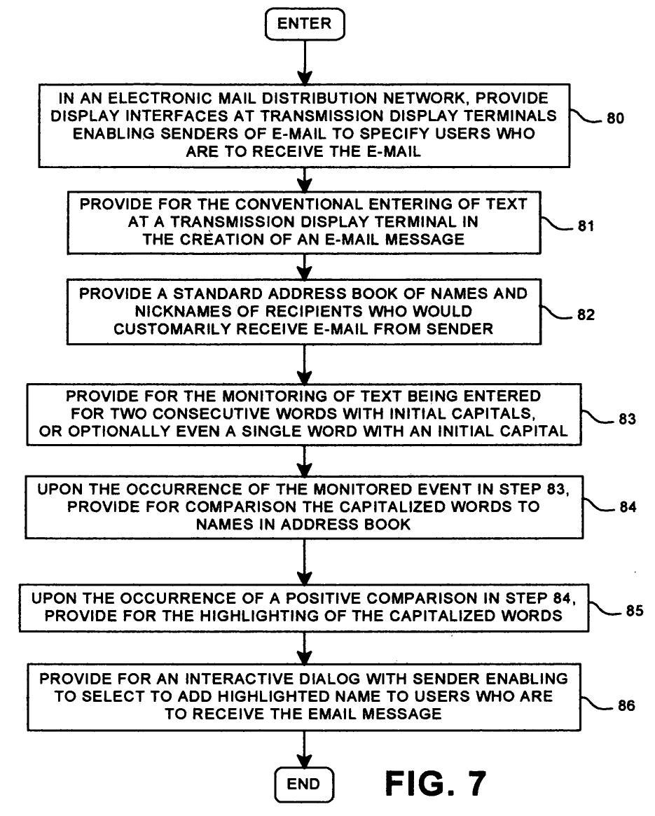

FIG. 7 is a flowchart showing the development of a process according to the present invention for prompting senders of E-Mail documents to add recipients of E-mail in response to the entering of one or two words with initial capital letters. In any standard E-Mail network system, enabling senders at display terminals to distribute E-Mail to specified users, step 80, (reference maybe made to such a distribution network as described in the text, The ABCs of Lotus Notes 4.5, R. Clayton, published by SYBEX Inc., San Francisco, 1997, particularly Chapter 18, pp. 367-398). There is provision for the conventional entering of text at a sending of E-Mail messages display terminal, step 81. There is provided a standard address book of names and nicknames of recipients to whom the sender usually sends E-Mail, step 82. Provision is made for the monitoring of the text being entered for two consecutive words with initial capitals or, optionally, even a single word with an initial capital, step 83. Upon the occurrence of the monitored event of step 83, provision is made for the comparison of the capitalized words to names in the address book, step 84. Upon the occurrence of a positive comparison in step 84, provision is made for the highlighting of the capitalized words, step 85, and an interactive dialog involving drop down menus of comparisons enable the sender to select the appropriate address associated with the highlighted name for inclusion in the recipients of the E-Mail message.

In accordance with an additional aspect of the invention, where a text document is attached to the E-Mail message, the attached text document may also be scanned for words with initial capital letters and a determination made as to whether a located word with an initial capital corresponds to a name in said address book; if yes, the corresponding name may selectively be added to said designated recipients of the E-Mail message.

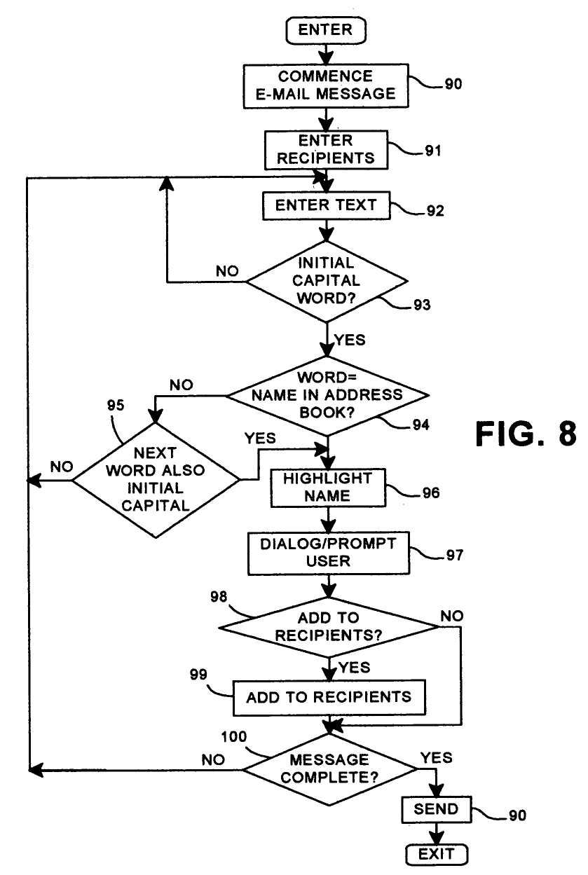

A simplified run of the process set up in FIG. 7 and described in connection with FIGS. 3 through 6 will now be described with respect to the flowchart of FIG. 8. At the display, terminal of the E-Mail sender, when an E-Mail message entry is commenced, step 90, there is provided an interface enabling the sender to indicate those individuals who are to receive, step 91. As text is entered, step 92, a continuous monitoring is done to determine, step 93, whether there is an initial capital word. If No, the entry of text continues, step 92. If Yes, then, step 94, a determination is made as to whether there is a match to a name in the address book. If Yes, the word is highlighted, step 96. If No, a further determination is made, step 95, as to whether the next word is also capitalized. If Yes, both words are highlighted, step 96. If No, the entry of text continues, step 92.

In any event, after the highlighting, step 96, the appropriate dialog prompt described with respect to FIGS. 3 through 6 is carried out until a determination is made whether there is a recipient to be added to the list, step 98. If Yes, the name is added to the list of recipients, step 99. Then, or if the decision in step 98 is No, a determination is made as to whether the sender has completed the message, step 100. If Yes, the message is sent, step 101, and the E-Mail process is exited. If No, the entry of text continues, step 92.

One of the preferred implementations of the present invention is in application program 40 made up of programming steps or instructions resident in RAM 14, FIG. 1, of Web server computers during various Web operations. Until required by the computer system, the program instructions may be stored in another readable medium, e.g. in disk drive 20, or in a removable memory, such as an optical disk for use in a CD ROM computer input, or in a floppy disk for use in a floppy disk drive computer input. Further, the program instructions may be stored in the memory of another computer prior to use in the system of the present invention and transmitted over a Local Area Network (LAN) or a Wide Area Network (WAN), such as the Internet, when required by the user of the present invention. One skilled in the art should appreciate that the processes controlling the present invention are capable of being distributed in the form of computer readable media of a variety of forms.

Although certain preferred embodiments have been shown and described, it will be understood that many changes and modifications may be made therein without departing from the scope and intent of the appended claims.

What is claimed is:

1. In a communication network with user access via a plurality of data processor controlled interactive display terminals, an electronic mail distribution system for enabling the sender of electronic mail (E-Mail) to control the distribution of sent E-Mail messages comprising:
means for interactively entering the text of an E-Mail message being sent on the display terminal;
means enabling the sender to designate the names of recipients of the E-Mail message;
address book means including the E-Mail addresses of a set of names of selected recipients who regularly receive E-Mail from the sender;
means for monitoring the text being entered for words with initial capital letters;
means responsive to said monitoring means for determining if a located word with an initial capital corresponds to a name in said address book; and
means for adding said corresponding name to said designated recipients of the E-Mail message.

2. The electronic mail distribution system of claim 1 wherein:
said means for monitoring monitor the text being entered for two consecutive words with initial capital letters; and
said means for determining determine if a located two consecutive words with initial capitals correspond to the first and last name of a recipient in said address book.

3. The electronic mail distribution system of claim 2 further including means, responsive to said means for determining, for enabling said sender to choose whether a determined corresponding first and last name should be added to said designated recipients of said E-Mail message.

4. The electronic mail distribution system of claim 3 wherein said means for enabling said sender to choose whether a name should be added to said designated recipients include:
means for highlighting said name; and
means for interactively designating said highlighted name.

5. The electronic mail distribution system of claim 1 further including means, responsive to said means for determining, for enabling said sender to choose whether a determined corresponding name should be added to said designated recipients of said E-Mail message.

6. The electronic mail distribution system of claim 5 wherein said means for enabling said sender to choose whether a name should be added to said designated recipients include:
means for highlighting said name; and
means for interactively designating said highlighted name.

7. In a communication network with user access via a plurality of data processor controlled interactive display terminals, an electronic mail distribution method for enabling the sender of E-Mail to control the distribution of sent E-Mail messages comprising:
interactively entering the text of an E-Mail message being sent on the display terminal;
enabling to sender to designate the names of recipients of the E-Mail message;
maintaining an address book including the E-Mail addresses of a set of names of selected recipients who regularly receive E-Mail from the sender;
monitoring the text being entered for words with initial capital letters;
determining if a located word with an initial capital corresponds to a name in said address book; and
adding said corresponding name to said designated recipients of the E-Mail message.

8. The electronic mail distribution method of claim 7 wherein:
said monitoring of the text being entered is for two consecutive words with initial capital letters; and
said determining is for whether a located two consecutive words with initial capitals corresponds to the first and last name of a recipient in said address book.

9. The electronic mail distribution method of claim 8 further including the step, responsive to said determining step, for enabling said sender to choose whether a determined corresponding first and last name should be added to said designated recipients of said E-Mail message.

10. The electronic mail distribution system of claim 9 wherein said step of enabling said sender to choose whether a first and last name should be added to said designated recipients includes the steps of:
highlighting said names; and
interactively designating said highlighted names.

11. The electronic mail distribution system of claim 7 further including the steps of:
attaching a text document to said E-Mail message;
scanning the attached text document for words with initial capital letters;
determining if a located word with an initial capital corresponds to a name in said address book; and
adding said corresponding name to said designated recipients of the E-Mail message.

12. The electronic mail distribution method of claim 7 further including the step, responsive to said step of determining, of enabling said sender to choose whether a determined corresponding name should be added to said designated recipients of said E-Mail message.

13. The electronic mail distribution method of claim 12 wherein said step of enabling said sender to choose whether a name should be added to said designated recipients includes the steps of:
highlighting said name; and
interactively designating said highlighted name.

14. A computer program having code recorded on a computer readable medium for enabling the sender of E-Mail to control the distribution of sent E-Mail messages in a communication network with user access via a plurality of data processor controlled interactive display terminals comprising:
means for interactively entering the text of an E-Mail message being sent on the display terminal;
means enabling to sender to designate the names of recipients of the E-Mail message;
address book means including the E-Mail addresses of a set of names of selected recipients who regularly receive E-Mail from the sender;
means for monitoring the text being entered for words with initial capital letters;
means responsive to said monitoring means for determining if a located word with an initial capital corresponds to a name in said address book; and
means for adding said corresponding name to said designated recipients of the E-Mail message.

15. The computer program of claim 14 wherein:
said means for monitoring monitor the text being entered for two consecutive words with initial capital letters; and
said means for determining determine if a located two consecutive words with initial capitals correspond to the first and last name of a recipient in said address book.

16. The computer program of claim 15 further including means, responsive to said means for determining, for enabling said sender to choose whether a determined corresponding first and last name should be added to said designated recipients of said E-Mail message.

17. The computer program of claim 16 wherein said means for enabling said sender to choose whether a name should be added to said designated recipients include:
means for highlighting said name; and
means for interactively designating said highlighted name.

18. The computer program of claim 14 further including:
means for attaching a text document to said E-Mail message;
means for scanning the attached text document for words with initial capital letters;
means for determining if a located word with an initial capital corresponds to a name in said address book; and
means for adding said corresponding name to said designated recipients of the E-Mail message.

19. The computer program of claim 14 further including means, responsive to said means for determining, for enabling said sender to choose whether a determined corresponding name should be added to said designated recipients of said E-Mail message.

20. The computer program of claim 19 wherein said means for enabling said sender to choose whether a name should be added to said designated recipients include:
means for highlighting said name; and
means for interactively designating said highlighted name.
